(19) United States
(12) Patent Application Publication
(10) Pub. No.: US 2018/0252293 A1
(43) Pub. Date: Sep. 6, 2018

(54) METHOD AND APPARATUS TO PROVIDE DYNAMIC ROTATIONAL HARMONIC CENTER OF MOMENT COMPENSATION FOR MANUFACTURING IMPERFECTIONS IN WHEELS

(71) Applicants: John Arthur Fee, Plano, TX (US); Terry Davis, Plano, TX (US)

(72) Inventors: John Arthur Fee, Plano, TX (US); Terry Davis, Plano, TX (US)

(21) Appl. No.: 15/908,562

(22) Filed: Feb. 28, 2018

Related U.S. Application Data
(60) Provisional application No. 62/464,586, filed on Feb. 28, 2017.

(51) Int. Cl. F16F 15/36; G01M 1/28

(52) U.S. Cl. CPC F16F 15/36; F16F 15/363; F16F 15/366; B60B 21/025; F16F 2230/24; F16F 2230/08; F16F 2232/02; G01M 1/28

(57) ABSTRACT

A method and apparatus for dynamically balancing a tire/wheel assembly of a motor vehicle is provided. The wheel of the tire/wheel assembly has raceways along the circumference of the wheel containing balancing media that provide dynamic rotational harmonic center of moment compensation for manufacturing imperfections. Balancing media may be solid bearings, fluid, or a combination thereof, and the balancing media moves along the raceways to certain areas of the wheel to compensate for the mass imbalances on the correspondingly opposing side of the wheel. The raceways have any combination of mathematically-described geometric cross-sectional area shapes, and the balancing media may be shaped accordingly. In another embodiment, the raceways may be noncontiguous and may have different orientations throughout the wheel. The present invention also provides sensors for real-time management of the balancing media to inform the driver of sudden changes in the state of the tire/wheel assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

### Technical Field

This invention relates to a method and apparatus for dynamically balancing a tire/wheel assembly of a motor vehicle, and more particularly, for providing dynamic rotational harmonic center of moment compensation for manufacturing imperfections in any wheel.

### Description of Related Art

The invention of the wheel has been around many centuries. The advantage of the wheel is obvious in its own right. Throughout time, mankind has attempted to improve the performance of the wheel. Some of those attributes included circularity, circumference regularity, center of mass, toe in, toe out, center of mass uniformity, and many other attributes.

In the case of automobile wheels, the wheels are manufactured separately from the tire. They are designed not as one unit but two separate units. As a result, irregularities in the wheels place undue strain on the tires and vice versa. For example, wheels and tires are never manufactured with the same mass all around. The wheel's valve stem hole subtracts a small amount of weight from its corresponding side of the wheel. Tires may have weight imbalances, whether from adjoining tire ply or from manufacturing deviation, as in one side of a tire may compose of more rubber than the other side of the tire. At high speeds, these small weight imbalances from both the wheels and the tires can easily become a large imbalance in centrifugal force, and thereby causes the tire/wheel assembly to spin with a kind of“galumphing” motion. In order to correct for these small weight imbalances that exist throughout the tire/wheel assembly, a wheel balancer is used at a fixed rotation speed, and the balance of the assembly is generated only at that rotational speed. Weights are generally mounted to the rim of the wheel to correct for the imbalances detected by the wheel balancer.

For example, FIG. 1 depicts a front view of a tire/wheel assembly 100 including a wheel 102 and a tire 104. The tire 104 has a center of mass, and the wheel 102 has another center of mass separate from the tire. Understanding the difference between these centers of mass also requires an understanding that those centers of mass may be separated along different planes. In a Cartesian system of planes, the centers of mass may differ in the x, y, and z-planes. To compensate for the differences, a weight 106 is typically added to the outside of the wheel. Weights come in pre-determined sizes and clamp onto the outside of the wheel. This standard system has three main weaknesses. First, the weight 106 can become detached leaving the tire/wheel assembly unbalanced. Second, the weight 106 is static. As the tire wears—and loses mass—the weight selected may no longer be appropriate. Third, the weight 106 is only attached in a single plane and at a fixed distance from the center of the tire/wheel assembly. Every year, millions of small weights are attached to tires by automotive technicians while balancing them. Traditionally, these weights have been made of lead. According to the US Environmental Protection Agency, worldwide these weights total more than 20,000 tons of lead annually but since lead is a toxic metal, political authorities and industrial groups are in the process of converting to materials that are less toxic.

FIG. 2 depicts a rear view of a wheel 200. As mentioned previously, because the wheel has a different center of mass as compared to the tire, balancing weights may also be placed on the rear side of a wheel (the side closest to the automobile) to counterbalance the balancing weights that would be placed on the front side of the wheel. Generally, these balancing weights for both the front and back of the wheel may comprise bang-on weights or adhesive weights. Bang-on weights are metallic weights of various denominations with a soft lead flange knocked onto the edge of the wheel with a hammer. Adhesive weights are strips of flat adhesive-backed lead squares, each square weighing one-quarter of an ounce, to be cut to size with clippers and stuck to the inside of the wheel. Specifically, the adhesive weights are stuck to the inside of the barrel, which is the part of the wheel between the outboard face (rear side) and the inboard wheel edge and is shaped to create the tire mounting structure such as the drop center and the flanges, behind the spokes of the wheel. However, the problem with these balancing weights is that they be scraped off, either by curbs and rocks or in mud, snow, and sand.

What is needed is a method and apparatus to provide dynamic rotational harmonic center of moment compensation for these manufacturing imperfections.

### SUMMARY

The invention herein disclosed and described provides a solution to the shortcomings in prior art in wheel balancing, and achieves the above noted goals through the provision of dynamic rotational harmonic center of moment compensations. Disclosed herein is an apparatus and related method for dynamic rotational harmonic center of moment compensations for manufacturing imperfections in wheels. The invention herein disclosed may also eliminate the need for tire rotations every ten thousand (10,000) miles.

In accordance with one embodiment of the present invention, a wheel for dynamic rotational harmonic center of moment compensations for manufacturing imperfections in the wheel and tire is provided. A wheel for use with a tire to provide dynamic rotation harmonic center of moment compensation is provided, comprising a first raceway within the wheel containing a balancing media, wherein the balancing media moves within the first raceway. Other embodiments include comprising a second raceway within the wheel containing a second balancing media, wherein the second balancing media moves within the second raceway. The balancing media may be bearings that are spherical, are oval, have a polygonal shape, or have a mathematically described shape. The balancing media may comprise fluid. The first raceway may be continuous or non-continuous or have a mathematically-described cross-section shape. The invention may further comprise sensors for detecting threshold and wear of the tire/wheel assembly by a processor either installed in the vehicle or at an analytical service facility.

In accordance with another embodiment, a method for dynamic rotational harmonic center of moment compensations for manufacturing imperfections in wheels is provided. A method for providing dynamic rotational harmonic center of moment compensations for manufacturing imperfections in a tire wheel assembly is provided, comprising adding balancing media within a set of raceways; rotating the tire/wheel assembly to provide a first rotational harmonic center of moment compensation; and setting in motion the tire/wheel assembly, whereby allowing the balancing media to equal the balance of the tire/wheel assembly to overcompensate irregularities in the tire/wheel assembly. Other embodiments include the balancing media comprising of fluid and/or bearings of any shape, the set of raceways having any combination of geometric shape, the set of raceways having the same geometric shape, the set of raceways having different geometric shapes, and the set of raceways being continuous. The invention may further comprise providing real-time management and analysis of rotating medium raceway positioning to a driver with sudden or gradual changes in tire wear.

In addition, another benefit is a system which can measure harmonic resonant frequencies during rotation and counter balancing locations to determine wheel alignment, camber and/or caster, toe in and toe out and any other mis-alignment parameters to indicate potential safety hazards with the tires, rims, and steering.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods and systems for carrying out several purposes of the present disclosed device. It is important, therefore, that the claims be regarded as including such equivalent construction and methodology insofar as they do not depart from the spirit and scope of the present invention.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a front view of a wheel.

FIG. 2 depicts a rear view of a wheel.

FIGS. 3A to 3E depict cross-sectional views of exemplary embodiments of a wheel with differently-shaped geometric raceway(s) incorporated into body of the wheel.

FIG. 4 depicts a cross-sectional view of an exemplary embodiment of a wheel with an oval raceway having a mobile weight system within.

FIG. 5 depicts a cross-sectional view of an exemplary embodiment of a wheel showing the center of mass and certain key angles and distances used to analyze the dynamic balance system.

FIGS. 6A and 6B depict a cross-sectional view of an alternative embodiment of a tire/wheel assembly with a channel for raceways.

FIGS. 7, 8A, and 8B depict a cross-sectional structural view of an exemplary embodiment of a tire/wheel assembly with double raceways.

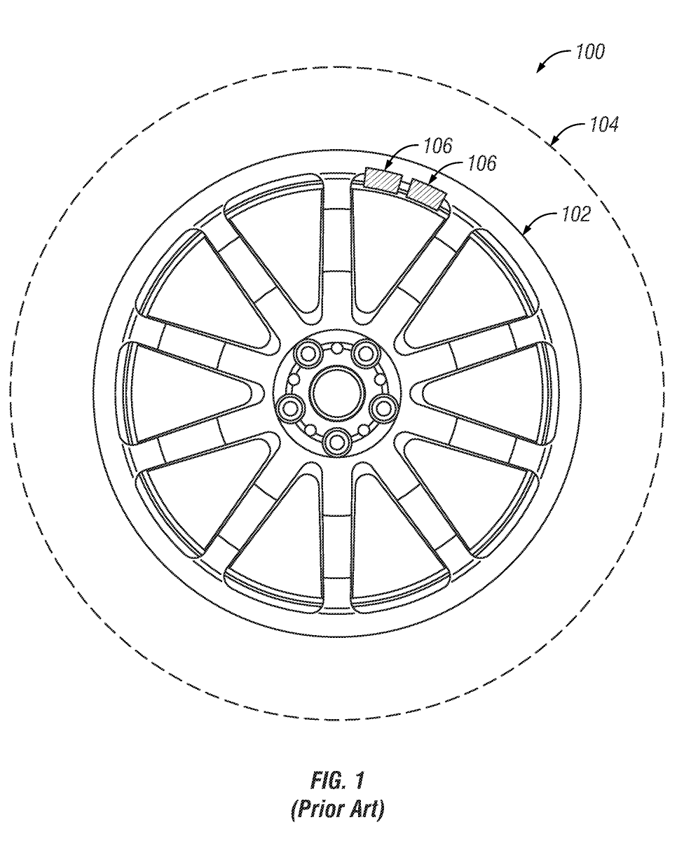

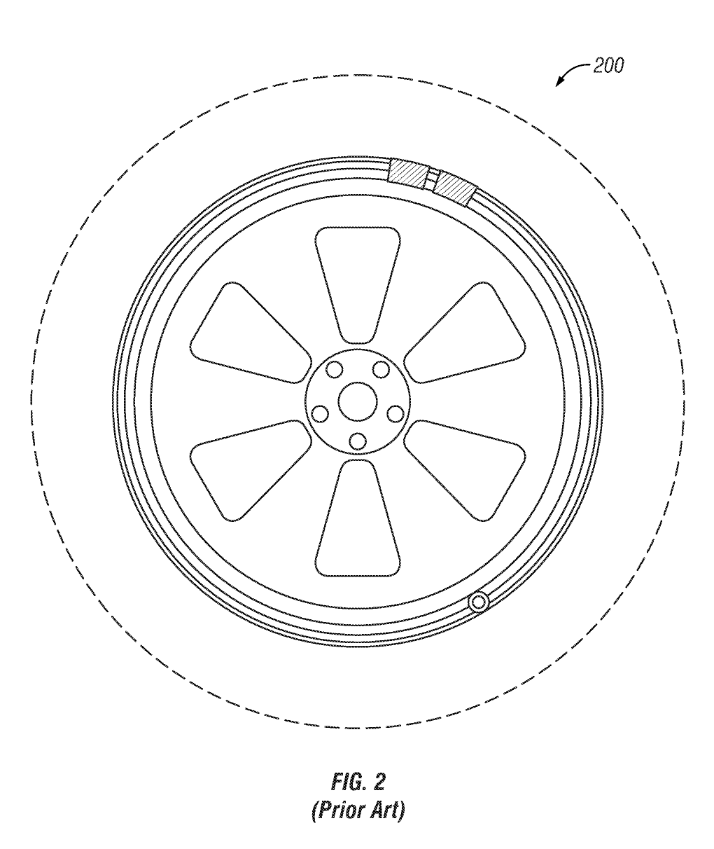

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. Further, the words “wheel” and “rim” are used interchangeably. The extension of the figures with respect to number, position, relationship, and dimensions of the parts to form the preferred embodiment will be explained or will be within the skill of the art after the following teachings of the present invention have been read and understood

### DETAILED DESCRIPTION

In the view of the foregoing, through one or more various aspects, embodiments and/or specific features or sub-components, the present disclosure is thus intended to bring out one or more of the advantages that will be evident from the description. The present disclosure makes reference to one or more specific embodiments by way of illustration and example. It is understood, therefore, that the terminology, examples, drawings, section, and embodiments are illustrative and not intended to limit the scope of the disclosure.

The present invention solves the problems of the static balancing weights by providing dynamic rotational center of moment compensations for the manufacturing imperfections in wheels, tires, and tire/wheel assemblies.

Generally, the center of mass of the tire from the frontal view is roughly located at the center of the wheel. Mathematically, this can be stated that the center of mass of the tire can be located at the point of origin (0,0,0) of a Cartesian x-y-z coordinate system. However, even though a tire/wheel assembly is generally considered completely round having one radius at all points, the wheel is not completely circular because of manufacturing imperfections introduced into both the tire and the wheel. Therefore, because there is not a consistent radius throughout the tire/wheel assembly, a single or multiple set of static weights can not perfectly balance the mass of tire/wheel assembly. Thus, in order to provide dynamic rotation center of moment compensations for the manufacturing imperfections in the tire/wheel assembly, the present invention comprises multiple raceways as part of the structure of the barrel portion of the wheel of the tire/wheel assembly. These multiple raceways will provide the dynamic mass compensations for the wheel and for the tire.

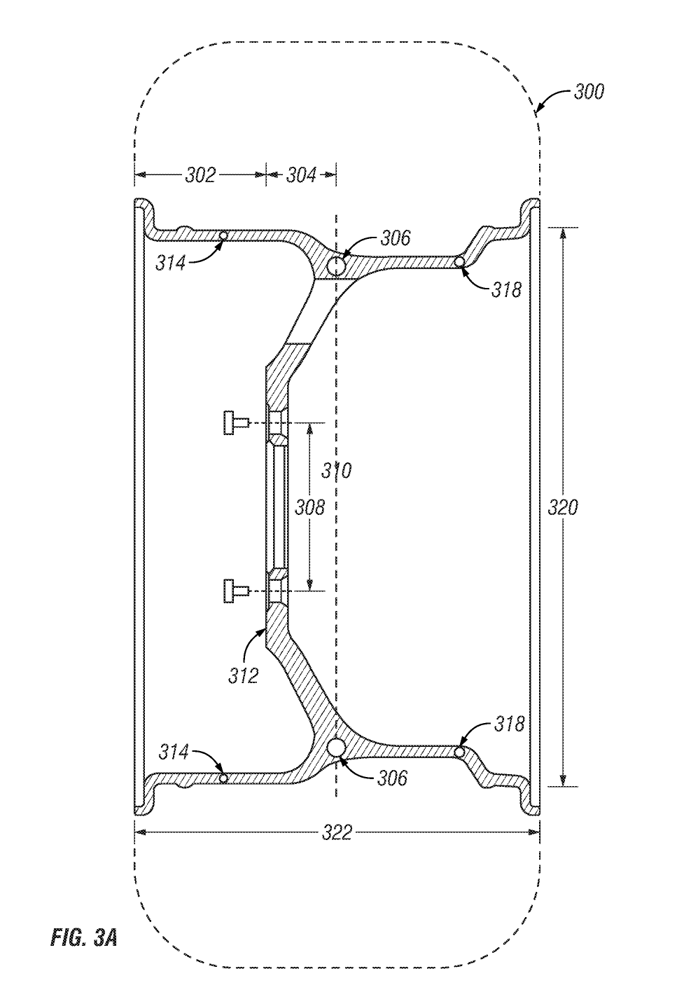

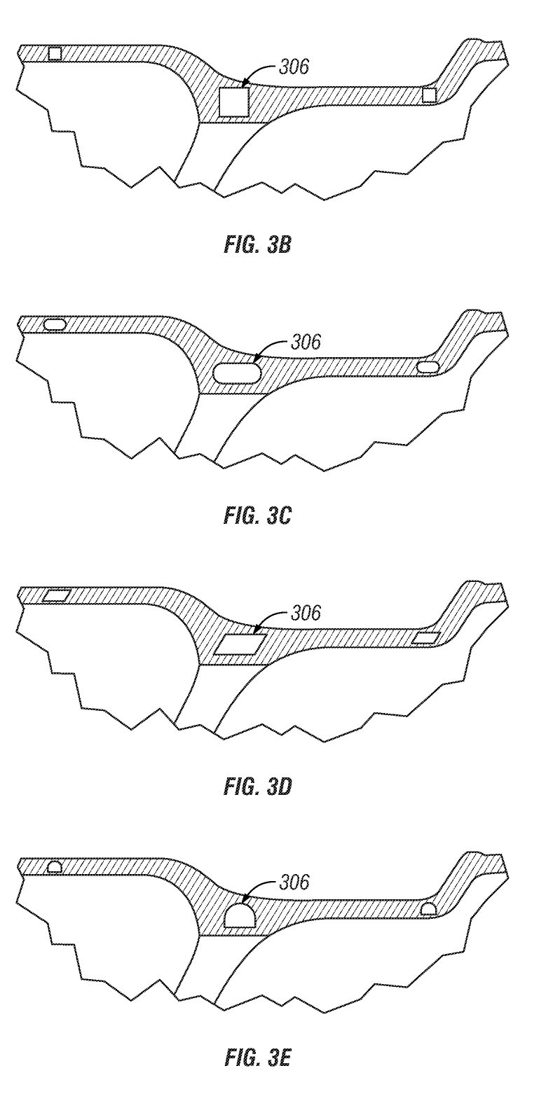

FIG. 3A depicts a cross-sectional view of an exemplary embodiment of a wheel 300 having a plurality of raceways 306. This wheel 300 has a diameter 320 and a width 322. Of course, the present invention can be used for any shape and size of wheel, and therefore the dimensions of the wheel does not limit the scope of the present invention. Furthermore, the wheel 300 has a designated centerline as indicated by centerline 310, and this centerline 310 denotes the middle of the wheel width. The centerline 310 also determines an offset 304 which is the distance from the wheel portion 312 used to mount the wheel to the vehicle to the wheel centerline 310, and the remaining space between the wheel portion 312 to the edge of the wheel 300 is the wheel backspace 302. This wheel offset 304 is generally measured in millimeters and results in positive, negative or zero offset. The present invention can be used with a wheel with any type of offset (positive, negative, or zero), so the wheel offset 304 does not limit the scope of the present invention. Additionally, the bolt circle diameter 308 does not limit the scope of the present invention.

The reference number 314 indicates the inside of the wheel, and the reference numeral 318 indicates the outside of the wheel.

FIG. 3A shows the uses of several raceways, each of which can contain balancing media. The shape of the raceway 306 is generally round. The balancing media can move through the raceway and can dynamically find an optimal position to counteract any imbalance in the rotating tire/wheel assembly. While three raceways 306, 314, and 318 are shown in this exemplary embodiment, there can be any number of raceways in the wheel. The advantage of having three raceways is that one raceway can be generally centered over the center of mass of the wheel at the wheel centerline 310 while the other two raceways can be placed on either side of the center of mass at the wheel centerline 310. This configuration of raceways allows for a more complete, balanced and complex balancing as compared simple weights clamped on the outside of the wheel. The size of each raceway is also important. Larger raceways will slightly lighten the wheel mass, but could also allow for more balancing media. In this illustration, the outer raceways are smaller in cross-sectional area.

FIGS. 3B to 3E illustrate alternative sectional areas for the raceways. Namely, the raceways can have any sectional shape, including square, oval, rhomboid, and semi-circular. The raceways have many different geometric shapes because a nearly perfect spherical raceway shape may not be allowed depending on where the raceway is placed in the wheel. Geometrically, the wheel shape may allow rectangular or square raceways because of geometrical limitations in the wheel. Secondly, an oval or square raceway may allow for smaller wear and tear on the balancing medium as they move to the balanced position on the rotating wheel. Thirdly, different geometrical shapes for the raceways may afford less tooling costs during manufacturing.

In another embodiment of the present invention, the raceways may form a continuous ring throughout the wheel. The raceways may also be linear or non-linear along the width of the wheel, such a raceway may travel along the width of the wheel in a non-linear fashion around the circumference of the wheel.

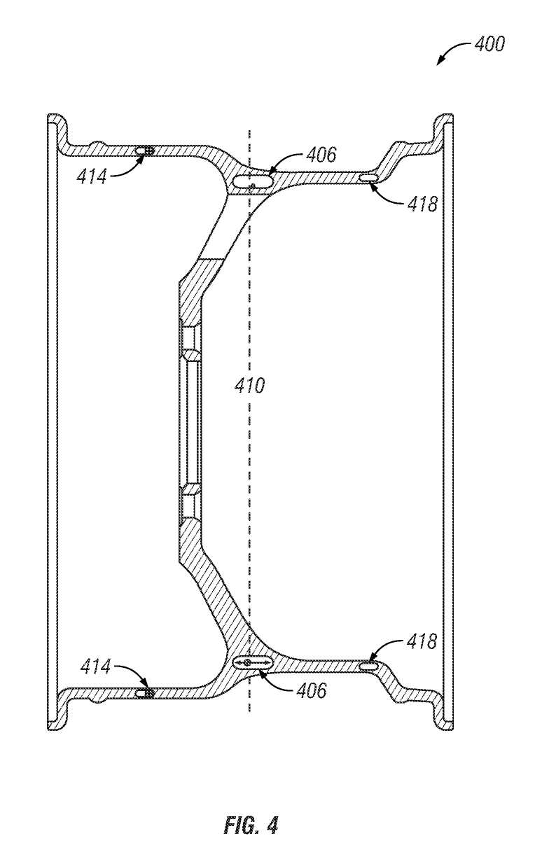

FIG. 4 depicts a cross-sectional view of an exemplary embodiment of the wheel of a tire/wheel assembly with several raceways based on the wheel's center of mass. In the present exemplary embodiment, the raceways 406 provide dynamic compensations based on the wheel's center of mass. The raceways 406 contain balancing media to move in and/or along the raceway 406. The balancing media may be of any shape or form or material, as long as the balancing media can roll, slide, or flow within the raceways. For example, the balancing media could be spherical ball bearings or rectangular bearings, as shown in the raceways of the present exemplary embodiment. Alternatively, the balancing media could include a fluid, or a combination of fluid and solids of different sizes and shapes. Fluid density for fluid balancing media may provide rotational ball bearing dampening. An advantage of the present invention is that the addition of multiple raceways that provide rotation around the wheel will provide harmonic balance mediums, and the mass is variable and it is tuned into the center of mass in the center of the wheel at any rotational speed (usually, 30 mph or greater).

Also as illustrated in FIG. 4, the balancing media in the raceway 406 may move laterally in the raceways so as to provide lateral balancing. By providing lateral balancing within raceway 406, other raceways in the wheel may provide finer balancing adjustments.

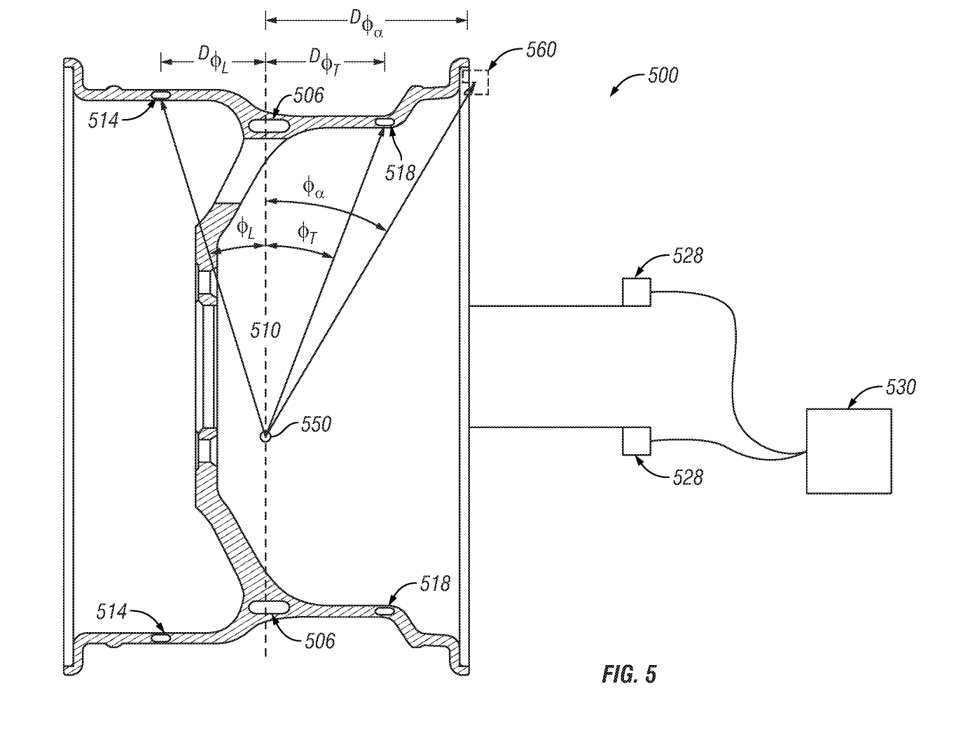

FIG. 5 depicts a cross-sectional view of an exemplary embodiment of a tire/wheel assembly with raceways, one based on the tire center of mass and the other based on the wheel's center of mass. In this exemplary embodiment of the present invention, there are tire raceways 506 for dynamic compensation based on the tire's center of mass and wheel raceways 514 and 518 dynamic compensations based on the wheel's center of mass. Two angles, φ_{L} and φ_{T}, are used to illustrate the effect of the balancing media used in raceways 514 and 518, respectively. In each case, the angle is measured from the center of mass represented by point 550. The center of mass 550, also known as the center of moment of inertia in rotational physics, may be located where the axle is for use in an automobile.

The balancing media when used in the wheel raceways, as mentioned, dynamically compensates for imbalances caused by manufacturing imperfections. Because of manufacturing imperfections, the masses on one side of the axle continuously have greater torque, and thereby the wheel becomes unbalanced and causes the wheel to rotate in at least one unintended direction and also the total momentum of the tire/wheel to keep changing direction in a periodic fashion. In general, torque, also known as moment of force, is calculated using the following equation: τ=F× D_{φ}_{ₙ}=F D_{φ}_{ₙ} sin D_{φ}_{ₙ} where F is the applied force, where D_{φ}_{ₙ} is the distance of the force applied from the center of moment, and where φₙ is the angle of force applied from the center of moment, in this case, the center of moment being the center of mass of the tire/wheel assembly. As illustrated, the current state of the art provides a weight 560 attached to the wheel of the tire/wheel assembly, so the angle between the wheel centerline 510 and the attached weight 560 measured from the center of mass point 550 is φ_{α}. The resulting moment, regardless of the amount of force applied, is much greater than zero because D_{φ}_{_{α}} sin φ_{α} is much greater than 0.

The present invention provides raceways for balancing media on both sides of the wheel centerline 510 with respective angles from the wheel centerline 510 measured from the center of mass point 550. The balancing media inside the raceways can dynamically shift to accommodate or correct any manufacturing imperfections, so that the resulting torque for the raceways is equal and the dynamic balancing by the balancing media creates balanced moment. The balanced moment results from the balancing media in the two raceways counteracting each other, and thereby producing balanced or net zero torque. In the exemplary embodiment, D_{φ}_{_{L}} sin D_{φ}_{_{L}} is equal to D_{φ}_{_{T}} sin D_{φ}_{_{T}} even though the distances from the raceways, D_{φ}_{_{L}} and D_{φ}_{_{T}} for each respective angle, to the wheel centerline 510 and the corresponding angles may not be equal.

In the present exemplary embodiment, monitors or sensors 528 (per tire/wheel assembly) can be used to detect the location of the balancing media and provide real-time spectral, temporal harmonic data, tire tread noise information to a CPU 530. The CPU 530 may be located on board the vehicle or at a service facility. The CPU 530 may be able to access information gathered by the sensors and analyze the real-time spectral, temporal harmonic data, and tire tread noise information. The information may be used in determining and detecting the threshold and wear of the tire/wheel assembly. The location of the balancing media or excessive torque could be relevant to informing the driver about unsafe wear pattern or depth of the tire's tread. It might even indicate the presence of a nail or other penetrating nuisance. Information from the CPU 530 may be transmitted to the driver via a mobile device or a computing device. When the tire wears, the balancing media in the raceways of the wheel change their harmonic balancing positions or angles to compensate for the wear in the tire, and the sensors detect the change, informing the driver. This dynamic balancing and dynamic re-balancing results in no need for ever requiring wheel balancing from using a new tire to a completely worn tire.

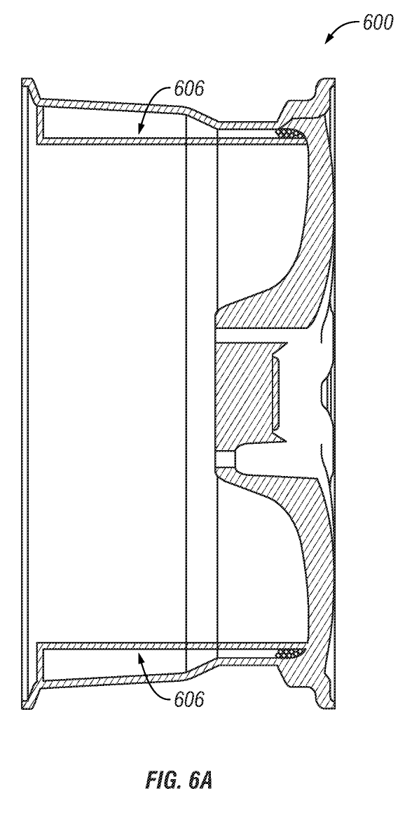

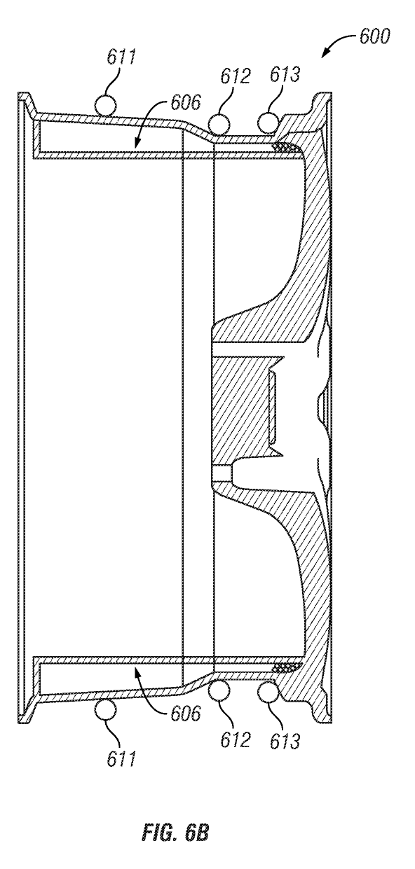

FIGS. 6A and 6B depict a cross-sectional view of an alternative embodiment of a tire/wheel assembly with a channel for raceways. The structure of the wheel 600 in FIGS. 6A and 6B comprises a channel 606 for raceways. The channel 606 may comprise any number of raceways to provide dynamic rotational harmonic center of moment compensations. The present invention is optimized for a tire/wheel assembly by provide multiple raceways around the center of the inside of the rim, as demonstrated in FIGS. 6A and 6B. These raceways within the channel 606, as disclosed previously, may be of any shape and form, either contiguous or non-contiguous, and any combination thereof. Furthermore, the channel 606 itself may act as a raceway as shown in FIGS. 6A and 6B. FIG. 6B also illustrates that one or more raceways 611, 612, and 613 may be applied on the outside of the rim and inside the tire. Raceways 611, 612, and 613 may be spot-welded to the rim using similar metals to prevent corrosion.

Any parameter of excess volume or mass of center of moment, left or right side of wheel, may be adjusted for volume density and offset from the wheel center of moment.

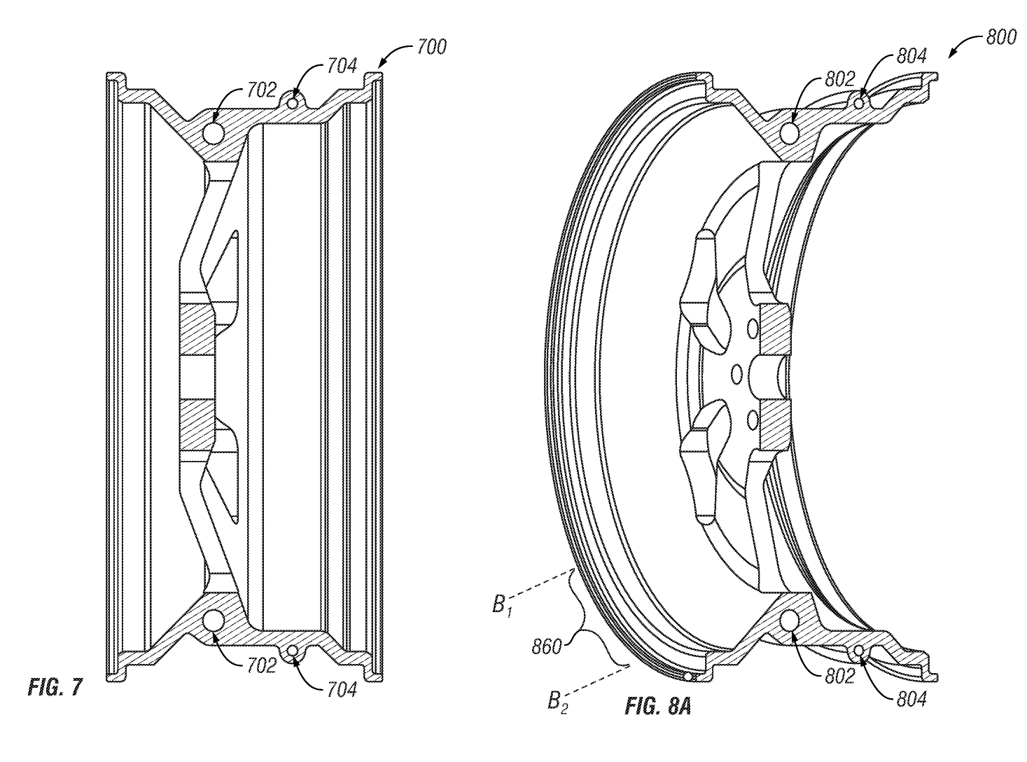

FIG. 7 depicts a cross-sectional structural view of an exemplary embodiment of a tire/wheel assembly with double raceways.

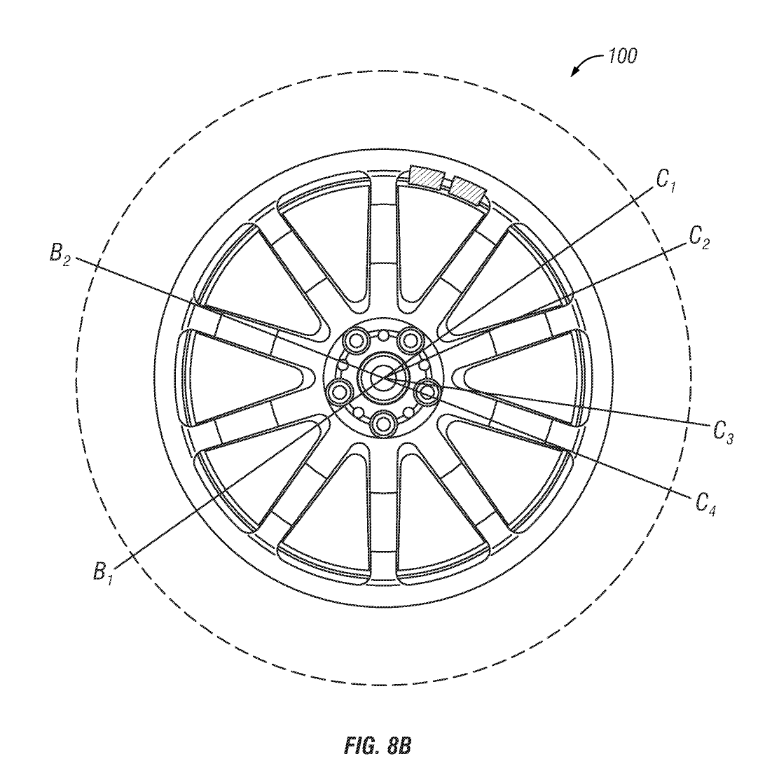

FIG. 8A depicts an isometric sectional structural view of an exemplary embodiment of a tire/wheel assembly with double raceways. The present exemplary embodiment of the present invention allows balancing media to run along these double raceways 802 and 804.

The balancing media in the raceways of the wheel dynamically balance the tire/wheel assembly by moving through the raceways to the appropriate compensating areas that correspond to the mass imbalances of the tire/wheel assembly. In the present exemplary embodiment, manufacturing imperfections appear on an arc of the tire/wheel assembly at area 860. Area 860 has a certain size, which is denoted as from B1 to B2. The resulting area of mass imbalance distribution along the tire/wheel assembly is described as Area_{Imbalance}=∫_{B1}^{B2} e^{-x}^{²}dx=½ \sqrt{π}. In order to compensate for this area of mass imbalance, the Area_{imbalance} will approximately be equal to Area_{compensating}, so that Area_{imbalance}−Area_{compensating}≅0.

FIG. 8B provides an exemplary illustration of the Area_{imbalance} and the Area_{compensating}, where the area from B1 to B2 denotes Area_{imbalance} and the areas from C1 to C2 and from C3 to C4 denote Area_{compensating}. The balancing media may move along the raceways such that they are in the compensating area, which is on the correspondingly opposite side of the wheel, Area_{compensating}. Area_{compensating} may be described as

Area_{compensation}=∫_{C1}^{C2}e^{-x}^{²}dx+∫_{C3}^{C4}e^{-x}^{²}dx=Total Area of Wheel Imbalance

where the distance from C1 to C2 represents the length of raceway 802 and the distance from C3 to C4 represents the length of the raceway 804. Each integral portion of the above equation represents a different raceway, and so because the present exemplary embodiment provides two raceways, there are only two integrals in the above equation. The integrals represent how much area of raceways 802 and 804 are needed in order to compensate for the imbalanced area at point 860. The compensating area is approximately at the opposite side of the wheel of a tire/wheel assembly.

The previous equation may be altered to reflect the number of raceways of the wheel. The Area_{compensating} may be described as the following equation:

Area_{compensation}=∫_{C1}^{C2}e^{-x}^{²}dx+∫_{C3}^{C4}e^{-x}^{²}dx+∫_{C5}^{C6}e^{-x}^{²}dx

This equation is customized for three raceways as shown in other figures of the present disclosure.

The above equations may be changed and altered in order to illustrate compensation for volumetric imbalances.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than recited unless the particular claim expressly states otherwise.

What is claimed:

1. A wheel for use with a tire to provide dynamic rotational harmonic center of moment compensation, comprising:
a first raceway within the wheel containing a balancing media, wherein the balancing media moves within the first raceway.

2. The wheel in claim 1, further comprising a second raceway within the wheel containing a second balancing media, wherein the second balancing media moves within the second raceway.

3. The wheel in claim 1, wherein the first balancing media comprises bearings.

4. The wheel in claim 3, wherein the bearings are spherical.

5. The wheel in claim 3, wherein the bearings are oval.

6. The wheel in claim 3, wherein the bearings have a polygonal shape.

7. The wheel in claim 3, wherein the bearings have a mathematically-described shape.

8. The wheel in claim 1, wherein the balancing media comprises fluid.

9. The wheel in claim 1, wherein the first raceway is continuous.

10. The wheel in claim 1, wherein the first raceway is non-continuous.

11. The wheel in claim 1, wherein the first raceway has a mathematically-described cross-section shape.

12. The wheel in claim 1, further comprising sensors for detecting threshold and wear of a wheel/tire assembly.

13. A method for providing dynamic rotational harmonic center of moment compensations for manufacturing imperfections in a tire/wheel assembly, comprising:
adding balancing media within at least one raceway;
rotating the tire/wheel assembly to provide a first rotational harmonic center of moment compensation; and
setting in motion the tire/wheel assembly, whereby, allowing the balancing media to equal the balance of a wheel of the tire/wheel assembly.

14. The method of claim 13, wherein the balancing media comprises at least one of fluid and solid bearings.

15. The method of claim 13, wherein each of the set of raceways has any combination of geometric shape

16. The method of claim 15, wherein the geometric shape for each of the at least one raceway is the same.

17. The method of claim 13, wherein the geometric shape for a first subset of the at least one raceway is different from the geometric shape of a second subset of the at least one raceway.

18. The method of claim 13, wherein the at least one raceway is continuous.

19. The method of claim 13, wherein the at least one raceway is non-continuous.

20. The method of claim 13, further comprising: providing real-time management and analysis of rotating medium raceway positioning to a driver with sudden or gradual changes in tire wear.
